(19) United States
(12) Patent Application Publication
(10) Pub. No.: US 2008/0310475 A1
(43) Pub. Date: Dec. 18, 2008

(54) Laser device having thermal lens astigmatism compensation devices and methods of use

(75) Inventor: Jean Eric Pesle, Sunnyvale, CA (US)

Correspondence Address: NEWPORT CORPORATION, 1791 DEERE AVENUE, IRVINE, CA, 92606, US

(73) Assignee: Newport Corporation, Irvine, CA (US)

(21) Appl. No.: 12/214,172

(22) Filed: Jun. 16, 2008

Related U.S. Application Data
(60) Provisional application No. 60/934,899, filed on Jun. 15, 2007.

(51) Int. Cl. H01S 3/08; H01S 3/091

(52) U.S. Cl. 372/70; 372/101

(57) ABSTRACT

The present application is directed to various embodiments of laser devices having at least one thermal lens astigmatism compensation device and methods of use and includes at least one pump source configured to irradiate at least one pump signal, a first gain device is communication with the pump source and configured to irradiate at least one first output signal in response to the pump signal, the first output signal having a first intensity profile Ip₁, and at least one thermal lens astigmatism compensation device in communication with the first gain device and configured to rotate the intensity profile Ip₁ of the first output to generated a compensated output, at least a second gain device is communication with the pump source and the compensation device and configured to receive the compensated output from the compensation device and irradiate at least one output signal having an output intensity profile Ip₀.

### CROSS-REFERENCE TO RELATED APPLICATIONS

The present application claims priority to U.S. Provisional Patent Application Ser. No. 60/934,899, filed Jun. 15, 2007, the entire contents of which are hereby incorporated by reference in its entirety herein

### BACKGROUND

Often, laser materials are optically side pumped such that the pump signal is perpendicular to the longitudinal axis of the gain material. As a result, the pump signal is perpendicular to the axis of the generated laser beam, which induces an asymmetry in the generated laser beam. Often, the intensity of the generated laser beam is non-uniform. More specifically, the portion of the gain material positioned proximate to the pump source produces a higher intensity output than the portion located distally from the pump source. Further, when the laser system includes one or more solid state lasing materials, side pumping the gain material may result in thermal lensing.

In response thereto, prior art systems have included compensating lenses or mirrors configured to overcome the induced thermal lensing phenomena. While these systems have proven somewhat successful in the past, a number of shortcomings have been identified. For example, often, the shape of the generated laser beam may change while propagating. A circular laser beam may become elliptical when propagating a relatively short distance, which also leads to a non-uniformity of the intensity profile of the laser beam. Further, the variation in the laser beam intensity profile and thermal lensing asymmetry are increased as the number of gain devices and/or pump intensity increases.

Thus, in light of the foregoing, there is an ongoing need for a device capable of compensating for the variation in the laser beam intensity profile and thermal lensing asymmetry of laser beams generated using side pumped architectures.

### SUMMARY

The present application is directed to various embodiments of laser devices having at least one thermal lens astigmatism compensation device and methods of use. More specifically, the various embodiments of thermal lens astigmatism compensation devices disclosed herein compensate for the variation in the laser beam intensity profile and thermal lensing asymmetry of laser beams generated using side pumped architectures.

In one embodiment, the present application is directed to a laser device having at least one thermal lens astigmatism compensation device therein and includes at least one pump source configured to irradiate at least one pump signal, a first gain device is communication with the pump source and configured to irradiate at least one first output signal in response to the pump signal, the first output signal having a first intensity profile Ip₁, at least one thermal lens astigmatism compensation device in communication with the first gain device and configured to rotate the intensity profile Ip₁ of the first output to generated a compensated output, at least a second gain device is communication with the pump source and the compensation device and configured to receive the compensated output from the compensation device and irradiate at least one output signal having an output intensity profile Ip₀.

In another embodiment, the present application is directed to a laser device having at least one thermal lens astigmatism compensation device therein and includes at least one pump source configured to irradiate at least one pump signal, a first gain device is communication with the pump source and configured to irradiate at least one first output signal in response to the pump signal, the first output signal having a first intensity profile Ip₁, at least one thermal lens astigmatism compensation device in communication with the first gain device and configured to rotate the intensity profile Ip₁ of the first output to generated a compensated output, wherein the compensation device comprising a prism, and at least a second gain device is communication with the pump source and the compensation device and configured to receive the compensated output from the compensation device and irradiate at least one output signal having an output intensity profile Ip₀.

In one embodiment, the present application is directed to a laser device having at least one thermal lens astigmatism compensation device therein and includes at least one pump source configured to irradiate at least one pump signal, a first gain device is communication with the pump source and configured to irradiate at least one first output signal in response to the pump signal, the first output signal having a first intensity profile Ip₁, at least one thermal lens astigmatism compensation device in communication with the first gain device and configured to rotate the intensity profile Ip₁ of the first output to generated a compensated output, wherein the compensation device comprising a first reflector in optical communication with the first gain device, a second reflector in optical communication with the first reflector, and at least a third reflector in optical communication with the second reflector, and at least a second gain device is communication with the pump source and the compensation device and configured to receive the compensated output from the compensation device and irradiate at least one output signal having an output intensity profile Ip₀.

Other features and advantages of the embodiments of a laser device having at least one thermal lens astigmatism compensation device and methods of use as disclosed herein will become apparent from a consideration of the following detailed description.

### BRIEF DECRIPTION OF THE DRAWINGS

Various embodiments of a laser device having at least one thermal lens astigmatism compensation device and methods of use will be explained in more detail by way of the accompanying drawings, wherein

FIG. 1 shows a schematic diagram of a laser device having at least one thermal lens astigmatism compensation device positioned between a first and second gain material;

FIG. 2 shows a schematic diagram of an alternate embodiment of a laser device having at least one thermal lens astigmatism compensation device positioned between a first and second gain material;

FIG. 3 shows a side view of an embodiment of a thermal lens astigmatism compensation device configured to rotate the intensity profile of an incident signal;

FIG. 4 shows a side view of an alternate embodiment of a thermal lens astigmatism compensation device configured to rotate the intensity profile of an incident signal; and

FIG. 5 shows a schematic diagram of an alternate embodiment of a laser device having at least one thermal lens astigmatism compensation device positioned between a first and second gain material.

### DETAILED DESCRIPTION

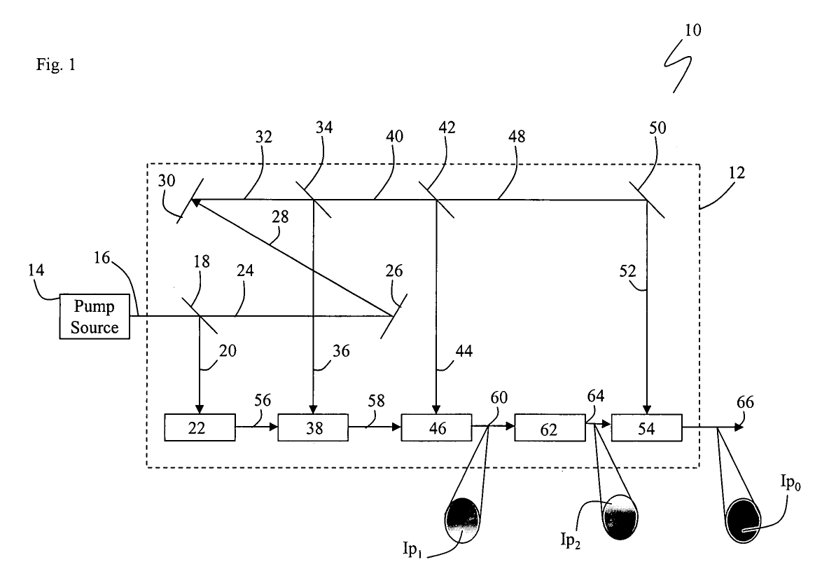

FIG. 1 shows an embodiment of a laser system having at least one compensation device positioned therein. In one embodiment, the laser system comprises a Nd:YAG laser, although those skilled in the art will appreciate that any variety of laser system may include at least of the one compensation devices disclosed herein. As shown, the laser system 10 includes at least one gain section or device 12 in communication with at least one pump source 14. In the illustrate embodiment, a single pump source 14 is in communication with gain section 12. Optionally, multiple pump devices 14 may be in communication with the gain section 12. Any variety and combination of pump sources 14 may be used the laser system 10, including, without limitation, flash lamps, light sources, light emitting diodes, diode lasers, fiber lasers, solid state lasers, gas lasers, dye lasers, disk lasers, slab lasers, electric power sources, and similar devices.

Referring again, the pump source 14 is configured to provide at least one pump signal 16 to the gain section 12. In the illustrated embodiment, the pump signal 16 is incident on a first optical element positioned within the laser system 12. In the illustrated embodiment, the first optical element 18 is configured to subdivide the pump signal 16 thereby forming at least one oscillator input signal 20 and at least one pump signal 24. As such, the first optical element may comprise a beam splitter, grating, or similar device. The oscillator input signal 20 is direct to at least one oscillator 22 by the first optical element 18.

Referring again to FIG. 1, the pump signal 24 is incident on a first reflector 26 configured to reflect the pump signal 28 to a second reflector 30. As shown in FIG. 1, the laser system 10 includes a first and second reflector 26, 30 to form a folded laser cavity, thereby decreasing the physical dimensions of the laser system 10. Optionally, the laser system 10 need not include a first and second reflector 26, 30. The second reflector 30 directs the pump signal 32 to a second optical element 34, which, like the first optical element 18, is configured to subdivide the pump signal 32 thereby forming at least one pre-amplifier input signal 36 directed to at least one pre-amplifier 38 and at least one pump signal 40.

As shown in FIG. 1, the pump signal 40 is directed to a third optical element 42 configured to subdivide the pump signal 40 thereby forming at least one first amplifier input signal 44 directed to at least one first amplifier 46 and at least one pump signal 48. The pump signal 48 is directed to a reflector 50 which directs the pump signal 48 to a second amplifier 54, thereby forming at least one second amplifier input signal 52. Those skilled in the art will appreciate that the laser system 10 may include any number of oscillators 22, pre-amplifiers 38, and amplifiers 46, 54.

Referring again to FIG. 1, the oscillator 22 generates at least one oscillator signal 56 in response to the incident pump signal 20. The oscillator signal 56 is directed to the pre-amplifier 38, which conditions the input radiation and generates at least one pre-amplifier output signal 58. The pre-amplifier output signal 58 is directed to the first amplifier 46 which amplifies the signal 58 and produces a first amplifier output signal 60 having a first intensity profile Ip₁.

As shown in FIG. 1, at least one compensation device 62 is positioned between the first and second amplifiers 46, 54. The compensation device 62 is configured to rotate the first amplifier output signal 60. In the illustrate embodiment, the compensation device 62 is configured to rotate the first amplifier output signal 60 approximately 180 degrees. Optionally, the compensator device 62 may be configured to rotate the first amplifier output signal 60 any number of degrees between about 1 degree and about 180 degrees. As shown in FIG. 1, during use the compensation device 62 rotates the first amplifier output signal 60 approximately 180 degrees thereby producing a compensated signal 64 having a second intensity profile IP₂. The compensated signal 64 is directed to the second amplifier 54 which amplifies the signal and produces an output signal 66 having an output intensity profile Ip₀.

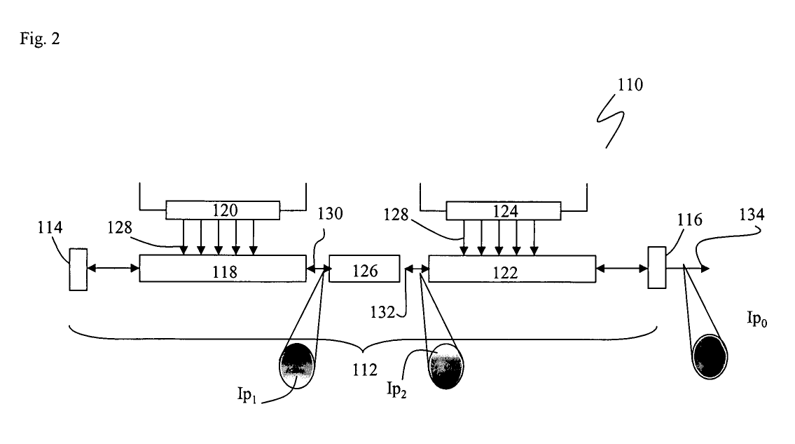

FIG. 2 shows an alternate embodiment of a laser system including at least one compensation device therein. As shown, the laser system 110 includes a laser cavity 112 defined by a first reflector 114 and at least a second reflector 116. In one embodiment, the first reflector 114 comprises high reflectivity device (reflectivity 99.5>) while the reflectivity of the second reflector 116 is less than the reflectivity of the first reflector 114. As such, the second reflector 116 may form an output coupler.

Referring again to FIG. 2, at least one gain device may be positioned within the laser cavity 112. In the illustrated embodiment, a first gain device 118 and first pump device 120 are positioned within the laser cavity 112. Similarly, a second gain device 122 and second pump device 124 are positioned with the laser cavity 112. Optionally, any number of gain devices and pump devices may be positioned within the laser cavity 112. In one embodiment, the first and second gain devices 118, 122 are manufactured from the same materials. In an alternate embodiment, the first and second gain devices 118, 122 are manufactured from different materials. Further, the first and second pump devices 120, 124 may be the same or may be different. Further, the single pump device may be used to pump the first and second gain devices 118, 122.

As shown in FIG. 2, at least one compensation device 126 is positioned between the first and second gain devices 118, 122 within the laser cavity. As shown in FIG. 2, the pump devices 120, 124 output at least one pump signal 128 to the first and second gain devices 118, 122. In response, the first gain device 118 outputs a first gain device signal 130 having a first intensity profile Ip₁ which is directed into the compensation device 126. Like the previous embodiment, the compensation device 126 is configured to rotate the first intensity profile Ip₁ of first gain device signal 130 any number of degrees between about 1 degree and about 180 degrees thereby generating a compensated signal 132 having a second intensity profile Ip₂ which irradiates the second gain device 122. Like the previous embodiment, the laser device 110 emits an output beam 134 having a uniform intensity profile Ip₀ and compensated for thermal lensing asymmetry.

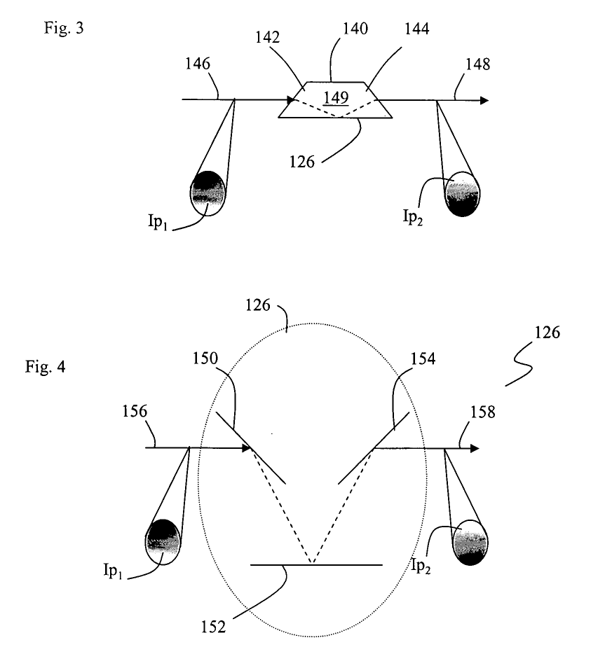

FIG. 3 shows an embodiment of a compensation device for use within a laser system. As shown, the compensation device 126 comprises a body 149 having a first face 142 and at least a second face 144. The first and second faces 142, 144 formed on the body 140 are non-parallel. In one embodiment, the compensation device comprises a dove prism. As such, the compensation device 126 may be manufactured from any variety of materials, including, without limitation, crystals, silica, glass, composite materials, and composite glass. As shown in FIG. 3, the intensity profile Ip₁ of an incident signal 146 is inverted or otherwise rotated by the compensation device 126 thereby producing a compensated output 148 having an intensity profile IP₂.

FIG. 4 shows another embodiment of a compensation device for use within a laser system. As shown, the compensation device 126 comprises a first reflector 150, second reflector 152, and a third reflector 154. The first and third reflectors 150, 154 are positioned to reflect an incident signal 156 to the second reflector 152. As shown in FIG. 4, like the previous embodiments, the intensity profile Ip₁ of an incident signal 156 is inverted or otherwise rotated by the compensation device 126 thereby producing a compensated output 158 having an intensity profile IP₂.

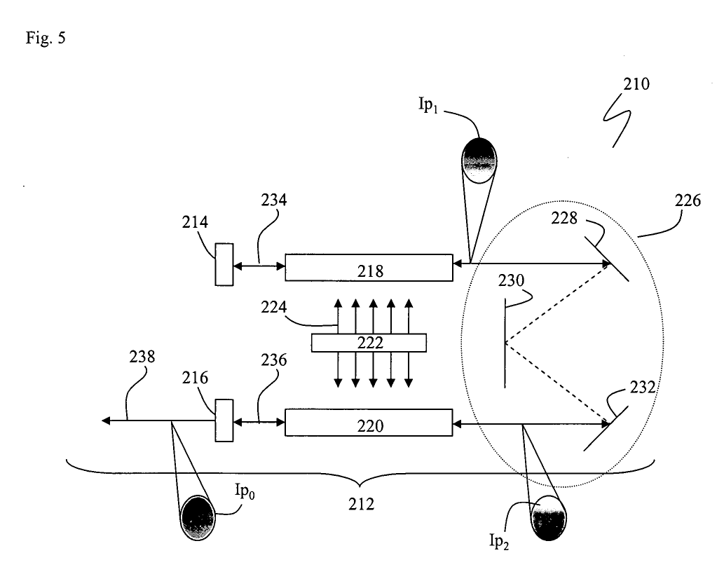

FIG. 5 shows another embodiment of a laser system having a thermal lensing astigmatism compensation device located therein. As shown in FIG. 5, the laser system 210 includes a laser cavity 212 defined by a first reflector 214 and a second reflector 216. Like the previous embodiments, the first reflector 214 may comprise a high reflectivity device while the second reflector 216 comprises a laser out coupler device. A first gain device 218 and at least a second gain device 220 may be positioned within the laser cavity 212. At least one pump device 222 is positioned proximate to the first and second gain devices 218, 220, and may be configured to direct one or more pump signals 224 to the first gain device 218, the second gain device 220, or both. At least one compensation device 226 may be positioned within the laser cavity 212. In the illustrated embodiment the compensation device 226 comprises a multiple reflector device similar to the device shown in FIG. 4. However, those skilled in the art will appreciate that the compensation device 126 shown in FIG. 3 could be adapted for use in the present system. Referring again to FIG. 5, the compensation device 226 includes a first reflector 228, a second reflector 230, and a third reflector 332.

As shown in FIG. 5, the first gain device 218 outputs a first gain device output 234 having an intensity profile Ip₁ which is directed to the compensation device 226. Like the previous embodiments, the compensation device 226 inverts of otherwise rotates the intensity profile of the first gain device output 234 and output a compensated output 236 having an intensity profile Ip₂ to the second gain device 220, which output a laser signal 238 having an intensity profile Ip₀ from the laser system 210.

Those skilled in the art will appreciate that the laser system described above are merely representative of some applications of the compensation devices disclosed herein and are not intended to limit the scope of the use of these devices. Any variety of additional optical elements may be used with the laser systems disclosed herein, including, without limitation, optical crystals, lenses, mirror, beam splitters, modulators, q-switches, mode-lockers, beam twisters, gratings, etalons, harmonic generation materials, and the like. Further, the compensation devices disclosed herein may be used in any variety of laser systems including, without limitations, dye lasers, flash lamp pumped YAG lasers, flash lamp pumped YLF lasers, harmonic generation lasers, and the like. Further, lasers including these compensation devices have been shown to exhibit improved beam shape and propagation, more efficient harmonic generations, and higher repetition rates with improved beam profile maintenance than laser devices not including these devise.

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed:

1. A laser device, comprising:
at least one pump source configured to irradiate at least one pump signal;
a first gain device is communication with the pump source and configured to irradiate at least one first output signal in response to the pump signal, the first output signal having a first intensity profile Ip₁;
at least one thermal lens astigmatism compensation device in communication with the first gain device and configured to rotate the intensity profile Ip₁ of the first output to generated a compensated output;
at least a second gain device is communication with the pump source and the compensation device and configured to receive the compensated output from the compensation device and irradiate at least one output signal having an output intensity profile Ip₀.

2. The device of claim 1 wherein the compensation device comprises a prism.

3. The device of claim 1 wherein the compensation device comprises a grating.

4. The device of claim 1 wherein the compensation device comprises:
a first reflector in optical communication with the first gain device;
a second reflector in optical communication with the first reflector; and
at least a third reflector in optical communication with the second reflector.

5. The device of claim 1 wherein the compensation device is configured to rotate the intensity profile Ip₁ of the first output between 1 degree and 180 degrees.

6. The device of claim 1 wherein the compensation device is configured to invert the intensity profile Ip₁ of the first output.

7. The device of claim 1 wherein at least one of the first and second gain devices comprises a ND:YAG gain material.

8. The device of claim 1 wherein at least one of the first and second gain devices comprises a dye laser gain material.

9. The device of claim 1 wherein the output signal has a substantially uniform output intensity profile Ip₀.

10. A laser device, comprising:
at least one pump source configured to irradiate at least one pump signal;
a first gain device is communication with the pump source and configured to irradiate at least one first output signal in response to the pump signal, the first output signal having a first intensity profile Ip₁;
at least one thermal lens astigmatism compensation device in communication with the first gain device and configured to rotate the intensity profile Ip₁ of the first output to generated a compensated output, wherein the compensation device comprising a prism; and
at least a second gain device is communication with the pump source and the compensation device and configured to receive the compensated output from the compensation device and irradiate at least one output signal having an output intensity profile Ip₀.

11. The device of claim 10 wherein the compensation device is configured to rotate the intensity profile Ip₁ of the first output between 1 degree and 180 degrees.

12. The device of claim 10 wherein the compensation device is configured to invert the intensity profile Ip₁ of the first output.

13. The device of claim 1 wherein at least one of the first and second gain devices comprises a ND:YAG gain material.

14. The device of claim 1 wherein at least one of the first and second gain devices comprises a dye laser gain material.

15. The device of claim 1 wherein the output signal has a substantially uniform output intensity profile Ip₀.

16. A laser device, comprising:
at least one pump source configured to irradiate at least one pump signal;
a first gain device is communication with the pump source and configured to irradiate at least one first output signal in response to the pump signal, the first output signal having a first intensity profile Ip₁;
at least one thermal lens astigmatism compensation device in communication with the first gain device and configured to rotate the intensity profile Ip₁ of the first output to generated a compensated output, wherein the compensation device comprising a first reflector in optical communication with the first gain device, a second reflector in optical communication with the first reflector, and at least a third reflector in optical communication with the second reflector; and
at least a second gain device is communication with the pump source and the compensation device and configured to receive the compensated output from the compensation device and irradiate at least one output signal having an output intensity profile Ip₀.

17. The device of claim 10 wherein the compensation device is configured to invert the intensity profile Ip₁ of the first output.

18. The device of claim 1 wherein at least one of the first and second gain devices comprises a ND:YAG gain material.

19. The device of claim 1 wherein at least one of the first and second gain devices comprises a dye laser gain material.

20. The device of claim 1 wherein the output signal has a substantially uniform output intensity profile Ip₀.
